(19) United States
(12) Patent Application Publication
(10) Pub. No.: US 2006/0170890 A1
(43) Pub. Date: Aug. 3, 2006

(54) Mirror and exposure apparatus having the same

(76) Inventor: Tetsuzo Ito, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/341,124

(22) Filed: Jan. 27, 2006

(30) Foreign Application Priority Data
Jan. 28, 2005 (JP) 2005-021912

(51) Int. Cl. G03B 27/42

(52) U.S. Cl. 355/53

(57) ABSTRACT

A mirror used for a laser beam, said mirror includes a substrate, an aluminum layer formed on the substrate, a dielectric layer formed on the aluminum layer, and an aluminum oxide layer provided between the aluminum layer and the dielectric layer, wherein said aluminum oxide layer has an optical thickness nd of 3.7 nm or more, where n is a refractive index for a using wavelength and d is a physical thickness.

### BACKGROUND OF THE INVENTION

The present invention relates generally to a mirror used for a laser beam with a wavelength of vacuum ultraviolet region (130 nm to 260 nm), and more particularly to a laminated structure of a mirror. The present invention is suitable, for example, for a mirror used for a catadioptric projection optical system of an exposure apparatus that uses an ArF excimer laser with a wavelength of approximately 193 nm.

The photolithography technology for manufacturing fine semiconductor devices, such as semiconductor memory and logic circuits, has conventionally employed a reduction projection exposure apparatus that uses a projection optical system to project a circuit pattern of a reticle (or mask) onto a wafer, etc. The projection exposure apparatus is required to transfer the mask pattern onto an object with high resolution and throughput. Recently, the resolution and throughput has been sensitive to a performance of an optical element of an optical system used for the exposure apparatus from demands of minute fabrication and efficient production (economical efficiency).

A mirror is one of the optical elements, and is required to have an enough durability for the excimer laser as a typical exposure light source (for example, KrF excimer laser with a wavelength of approximately 248 nm and ArF excimer laser with a wavelength of approximately 193 nm). The mirror needs to have an enough reflectance (incident angle property) for a large incident angle width of the laser beam oscillated by vacuum ultraviolet region, and uses an aluminum (Al) film that has an excellent incident angle property. However, a laser durability of Al is low, a reflectance decreases by a deterioration, and a reflection phase changes. The method of using the Al with high reflectance or the method of irradiating hydrogen gas to the deterioration part and returning to note that a cause of the deterioration is oxidization, have proposed to solve this problem. See, for example, Japanese Patent Application, Publication No. 2004-260081.

However, these methods are not perfect, and do not satisfy the recent demands of minute fabrication and economical efficiency. Moreover, in a metal mirror, a reflectance difference between p-polarized light and s-polarized light increases according to an increase of the incident angle, and there is the problem that an imaging performance differs in a rectangular direction. Then, Japanese Patent Application, Publication No. 2003-14921 has proposed a method of forming a dielectric multilayer film on the Al film having the reflectance of 85% or more.

For example, there is Japanese Patent No. 3,478,819 as other conventional technology.

Recently, a polarized illumination has proposed as one means to achieve the minute fabrication. The polarized illumination is an illumination method that controls a polarization condition of the light illuminated the mask. For example, the polarized illumination eliminates a TM mode light that decreases an imaging contrast, and illuminates the mask only using a TE mode light that has an electric field direction perpendicular to an incident surface of the light. The polarized illumination needs to severely control the reflection phase condition of the optical element. However, the mirror of Japanese Patent Application, Publication No. 2003-14921 does not have the laser durability with a level that is satisfied to the demand of the polarized illumination, and does not have the incident angle property, polarization property, and reflection phase property, either.

### BRIEF SUMMARY OF THE INVENTION

Accordingly, the present invention is directed to a mirror and an exposure apparatus having the same, which has enough durability for a laser beam oscillated in the vacuum ultraviolet region.

A mirror according to one aspect of the present invention used for a laser beam, said mirror includes a substrate, an aluminum layer formed on the substrate, a dielectric layer formed on the aluminum layer, and an aluminum oxide layer provided between the aluminum layer and the dielectric layer, wherein said aluminum oxide layer has an optical thickness nd of 3.7 nm or more, where n is a refractive index for a using wavelength and d is a physical thickness.

A mirror according to another aspect of the present invention used for a laser beam, said mirror includes a substrate, an aluminum layer formed on the substrate, and a dielectric layer formed on the aluminum layer, wherein an average reflectance is 85% or more, a reflection phase difference is ±15° or less, and a difference between a reflected p-polarized light and a reflected s-polarized light is within 10%, within an angular range of a central incident angle of 45° to ±15°.

A fabrication method according to another aspect of the present invention for fabricating a mirror, said fabrication method includes steps of forming an aluminum layer on a substrate, forming an aluminum oxide layer having an optical thickness of 3.7 nm or more by oxidizing a surface of the aluminum layer, and forming a dielectric layer on the aluminum oxide layer.

An exposure apparatus includes an illumination optical system for illuminating a pattern of a mask using a laser beam from a laser light source, and a projection optical system for projecting the pattern onto an object, wherein at least one of the illumination optical system and the projection optical system includes the above mirror.

A device fabrication method according to another aspect of the present invention includes the steps of exposing an object using the above exposure apparatus, and performing a development process for the object exposed.

Other objects and further features of the present invention will become readily apparent from the following description of the preferred embodiments with reference to the accompanying drawings.

### BRIEF DESCRIPTION OF THE DRAWINGS

FIG. 1 is a schematic sectional view of a mirror as one aspect according to the present invention.

FIG. 2 is a graph for explaining a property without an alumina layer and a dielectric layer in the mirror shown in FIG. 1.

FIG. 3 is a graph for explaining a polarization property without a dielectric layer in the mirror shown in FIG. 1.

FIG. 4 is a graph for explaining a phase property without a dielectric layer in the mirror shown in FIG. 1.

FIG. 5 is a graph for explaining a laser durability without a dielectric layer in the mirror shown in FIG. 1.

FIG. 6 is a graph for explaining a property without an alumina layer in the mirror shown in FIG. 1.

FIG. 7 is a flowchart for explaining how to fabricate the mirror shown in FIG. 1.

FIG. 8 is a graph for explaining a decrease of a mirror property by a contamination of an Al layer.

FIG. 9 is a graph for explaining a laser durability when forming a thin film of not an alumina layer but other materials on an Al layer.

FIG. 10 is a graph of a film design spectral property when a dielectric layer of the mirror shown in FIG. 1 is 4 layers.

FIG. 11 is a graph of a simulation result of a phase difference when a dielectric layer of the mirror shown in FIG. 1 is 4 layers.

FIG. 12 is a graph of a laser durability of the mirror shown in FIG. 1.

FIG. 13 is a graph of a reflection phase difference property of the mirror shown in FIG. 1.

FIG. 14 is a schematic block diagram of an exposure apparatus having the mirror shown in FIG. 1.

FIG. 15 is a flowchart for explaining how to fabricate devices (such as semiconductor chips such as ICs, LCDs, CCDs, and the like)

FIG. 16 is a detail flowchart of a wafer process in Step 4 of FIG. 15.

### DETAILED DESCRIPTION OF THE PREFERRED EMBODIMENTS

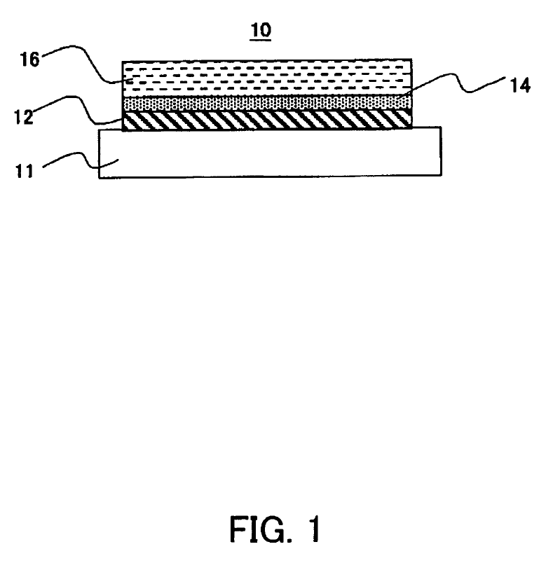

With reference to the accompanying drawings, a description will be given of a mirror 10 as one aspect according to the present invention. FIG. 1 is a schematic sectional view of the mirror 10. The mirror 10 includes a substrate 11, an Al layer (aluminum layer) 12 formed on the substrate 11, an alumina layer (Al₂O₃ layer) 14 with an optical thickness of 3.7 nm or more formed on the Al layer 12, and a dielectric layer 16 formed on the alumina layer 14.

The Al layer 12 gives an enough reflectance (incident angle property) for a large incident angle width of a laser beam oscillated in vacuum ultraviolet region to the mirror 10.

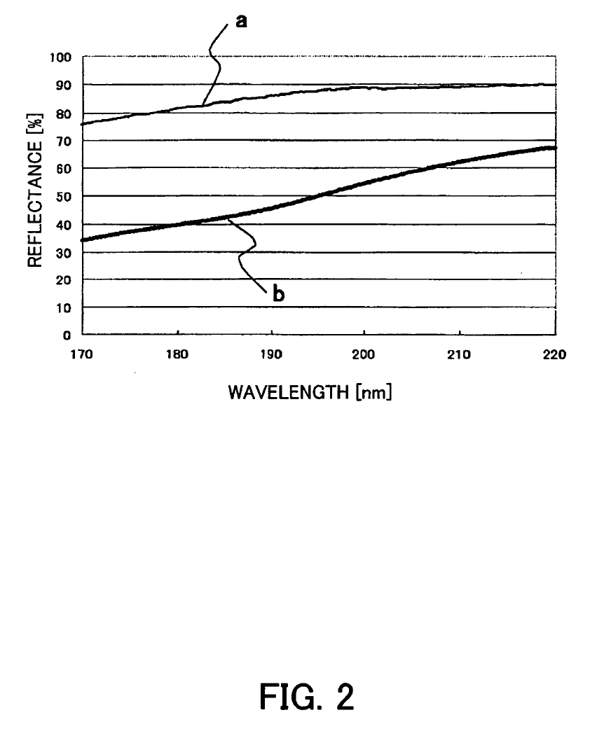

However, a laser durability of the Al layer 12 is low. For example, if ArF excimer laser of 1 mJ/cm² is irradiated for 4.0×10+8 pls to the Al layer 12, the reflectance deteriorates as shown in FIG. 2. In FIG. 2, a is a reflectance (incident angle is 45°) before laser irradiation, and b is a reflectance (incident angle is 45°) after laser irradiation (hereafter, a is a spectral property (45°) before laser irradiation, and b is a spectral property (45°) after laser irradiation).

Then, the alumina layer 14 is formed on the Al layer 12 to improve the laser durability. The alumina layer 14 preferably has an optical thickness nd of 3.7 nm or more and 20 nm or less. The optical thickness (n×d) is defined by a multiplication of a refractive index n of the film in a using wavelength and a physical thickness d. In this application, the alumina layer 14 is defined as a layer which main components are Al atom and O atom and a refractive index in a wavelength of 193 nm is 1.3 to 1.96 to clearly distinguish a boundary of the Al layer 12 and the alumina layer 14. Moreover, the using wavelength is an assumption (target) wavelength of the light irradiated to the mirror (when the wavelength has a band, it is a main wavelength). For example, when the mirror is used for a projection optical system of an exposure apparatus with a light source wavelength of 193 nm, the using wavelength is 193 nm.

If the optical thickness of the alumina layer 14 is smaller than 3.7 nm, the laser durability decreases. This can be inferred from FIG. 2. If the Al layer is left in the atmosphere, the surface quickly and naturally oxidizes, and the aluminum oxide layer (alumina layer) is formed on the surface. Therefore, in the Al layer 12 measured in FIG. 2, strictly, the surface of the Al layer naturally oxidizes between the durability measurement from film forming, the alumina layer may be formed. However, the laser durability is low. This is because the thickness is very thin though the alumina layer by the natural oxidation was formed. The alumina layer by the natural oxidation does not become thick (the optical thickness of about 3.7 nm) like the present invention. However, in the natural oxidation, the boundary of the Al layer and the alumina layer is continuous, and it is difficult to distinguish the boundary. Since the alumina layer is defined as the above-mentioned (the layer which the refractive index in the wavelength of 193 nm is 1.6), the thickness is clear.

In the instant embodiment, the mirror 10 has the enough laser durability, and this is in the state that the decrease of the reflectance is almost 0 (or within 1%), even if the light with an energy of the usually exposure used for the exposure apparatus (described later). Concretely, when a pulse light of about 1 mJ/cm² is irradiated for 10+8 pls (pulse) to the mirror, the decrease of the reflectance is almost 0 (or within 1%). On the other hand, when the optical thickness of the alumina layer 14 is larger than 20 nm, the absorption amount of the light by the alumina layer 14 cannot be disregarded (becomes large) , and the reflectance of the entire mirror decreases.

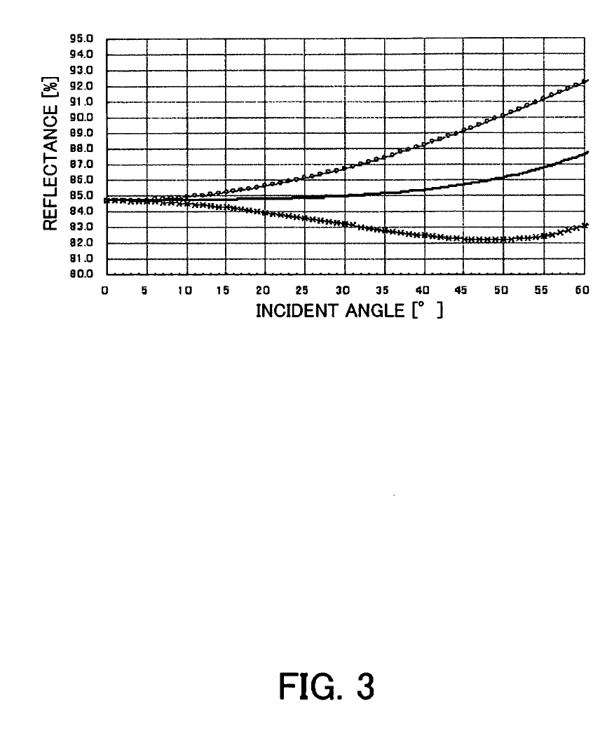

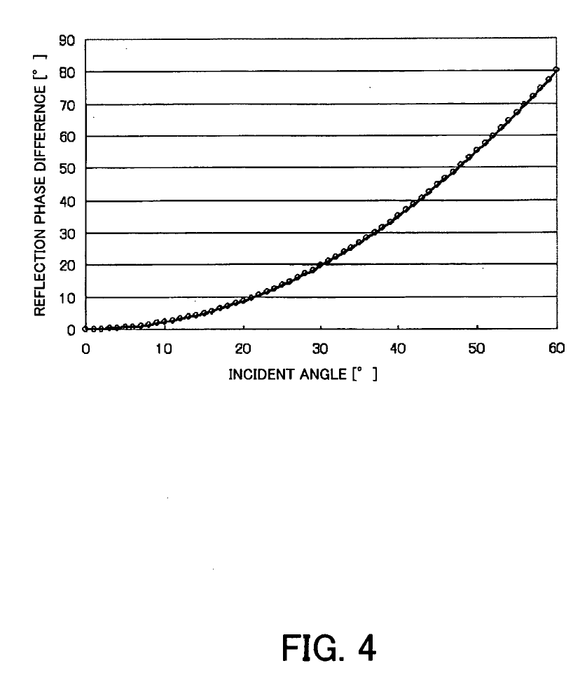

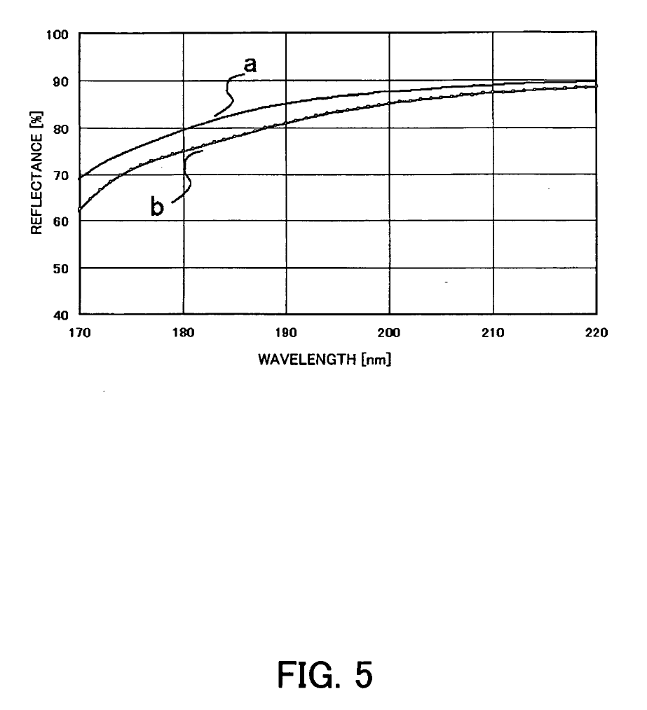

The dielectric layer 16 improves the reflection phase property, laser durability, polarization property, and reflectance. The dielectric layer 16 is preferably 1 layer or more and 4 layers or less, and the optical thickness is preferably 43 nm or more and 300 nm or less. If the dielectric layer 16 does not exist or the optical thickness is smaller than 43 nm, the polarization property and reflection phase property deteriorates. For example, a polarization property (angle property of the reflectance of p-polarized light and s-polarized light) of the mirror without the dielectric layer (only Al and alumina layers) is shown in FIG. 3. In FIG. 3, a O line is the s-polarized light, a x line is the p-polarized light, and a continuous line is an average random polarization reflectance of the s-polarized light and p-polarized light. The reflectance of the s-polarized light and p-polarized light roughly dissociates as the incident angle becomes large. When the dielectric does not exist, the reflection phase property exceeds 10% of a reflection phase difference from the 22° of the incident angle as shown in FIG. 4. Moreover, as shown in FIG. 5, the mirror without the dielectric does not have the enough laser durability, if the ArF excimer laser of 1 mJ/cm²is irradiated for 5.0×10+8 pls, the reflectance decreases.

On the other hand, if the dielectric layer 16 is 5 layers or more or the optical thickness is larger than 300 nm, the reflection phase property deteriorates. If the dielectric layer 16 is 2 layers or more, it becomes a dielectric multilayer film.

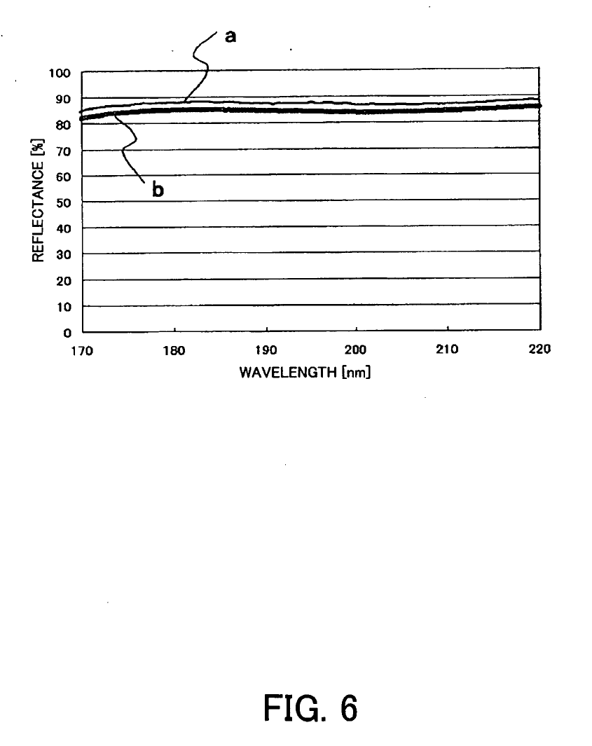

Forming the dielectric multilayer film on the Al layer 12 is also considered as Japanese Patent Application, Publication No. 2003-14921. However, the mirror which 4 layers of the dielectric multilayer film of about 30 nm are formed on the Al layer 12 buffers the deterioration rather than the mirror of only the Al layer 12. If ArF laser of 1 mJ/cm² is irradiated for 1.1×10+9 pls, the mirror deteriorates as shown in FIG. 6. Therefore, the dielectric layer 16 is preferably formed after forming the alumina layer 14 on the Al layer 12.

The alumina layer is generally known as a dielectric thin film. However, the alumina layer 14 directly formed on the Al layer 12 is distinguished from the dielectric layer 16 formed on it. Moreover, when the dielectric layer is the multilayer film, the alumina (Al₂O₃ layer) is included as a layer constituted the multilayer film, and this alumina layer is a part of the dielectric layer.

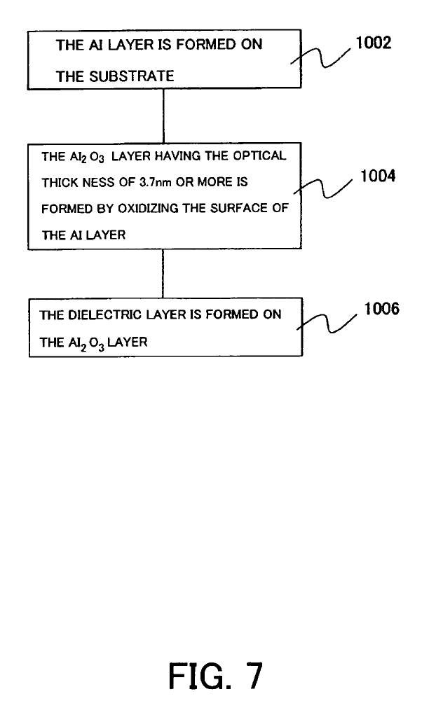

A fabrication method of the mirror 10 is shown in FIG. 7. First, the aluminum layer is formed on the substrate (step 1002). The substrate 11 is general materials, such as silica glass, calcium fluoride (CaF₂), magnesium fluoride (MgF₂), and BK7. However, if it is materials, such as Si wafer and ceramics, which can process a surface roughness to small, materials that does not transmit the laser beam can also be used. The Al layer 12 is formed by techniques, such as a vacuum evaporation and sputtering. The Al layer 12 uses high purity Al material. Then, if the Al layer 12 is formed by a film forming condition with a film forming rate of 20 A/s in a forming film chamber with enough low vacuum, the reflectance of 90% for a wavelength of 193 nm can be achieved. Moreover, if high reflectance can be obtained, the Al layer 12 may be formed using techniques, such as CVD (Chemical Vapor Deposition) and plating.

Next, the alumina layer 14 having the optical thickness of 3.7 nm or more is formed by oxidizing the surface of the Al layer 12 (step 1004). In the instant embodiment, the alumina layer 14 is formed by positively oxidizing the surface of the Al layer 12. In other words, the instant embodiment mounts a film forming apparatus to evaporate the Al layer 12, forms the alumina layer 14 using an ion gun that irradiates oxygen plasma, and can execute the steps 1002 and 1004 with one apparatus. Although oxidization may use oxygen plasma like the instant embodiment, may use ozone. The present invention does not limit the oxidization method.

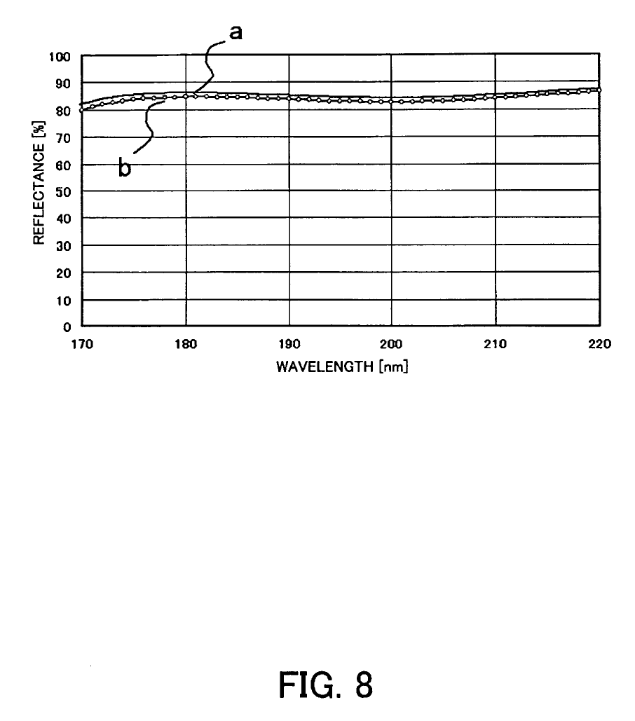

The subtlety alumina layer 14 can also be formed on the Al layer 12 using sputtering, vacuum evaporation, etc., without using oxidization. The surface oxidization of metal Al preferably execute without breaking the vacuum state, after forming the Al layer. For example, when oxidizing the surface using another apparatus after forming the film, it must be cautious of contamination of the surface of the Al layer 12 in the meantime. If the surface of the Al layer 12 is once exposed to the atmosphere and is contaminated, the laser durability does not becomes a predetermined as shown in FIG. 8 even if the alumina layer 14 is formed by the irradiation of the ion gun after that.

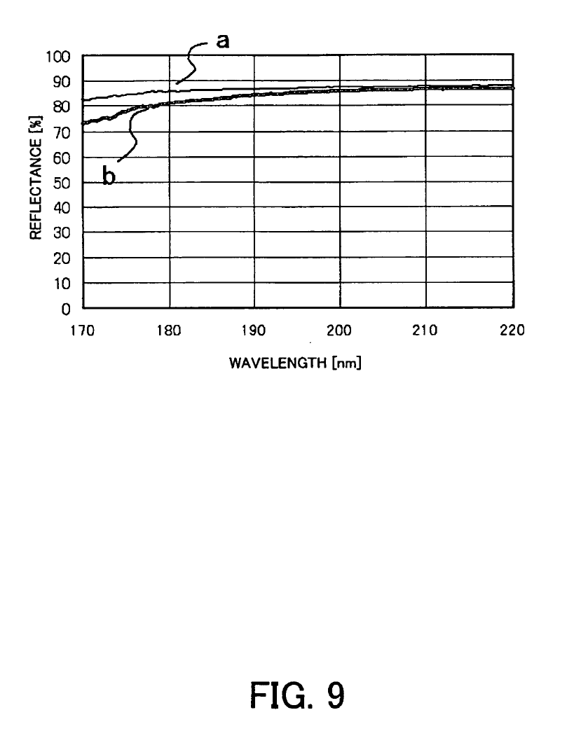

The alumina has a high film density, and can fully protect the deterioration of the Al layer 12. For example, when a MgF₂ layer and SiO₂ layer disclosed in Japanese Patent Application, Publication No. 2003-14921 are used instead of the alumina layer 14, if the ArF laser of 0.7 mJ/cm² is irradiated for 8.0×10+8 pls, the laser durability does not become the predetermined as shown in FIG. 9. FIG. 6B shows the laser durability using the MgF₂ layer instead of the alumina layer. a is a reflectance before laser irradiation, and b is a reflectance after laser irradiation. The decrease of the reflectance after laser irradiation is large, and the laser durability is inadequate.

Next, the dielectric layer 16 is formed by the low resistance heating vacuum evaporation method, the ion beam vacuum evaporation method, the sputtering method, etc. on the alumina layer 14 (step 1006). The dielectric layer 16 uses a fluoridation film and an oxidization film. When fabricating the mirror for ArF excimer laser, LaF₃, GdF₃, NdF, and SmF₃ etc. are used as a high index material of the fluoridation film. Moreover, AlF₃, MgF₂, and Na₂Al₃F₅ etc. are used as a low index material. Al₂O₃ etc. are used as a high index material of the oxidization film, SiO₂ etc. are used as a low index material of the oxidization film, and materials with small film absorption for a wavelength of 193 nm uses.

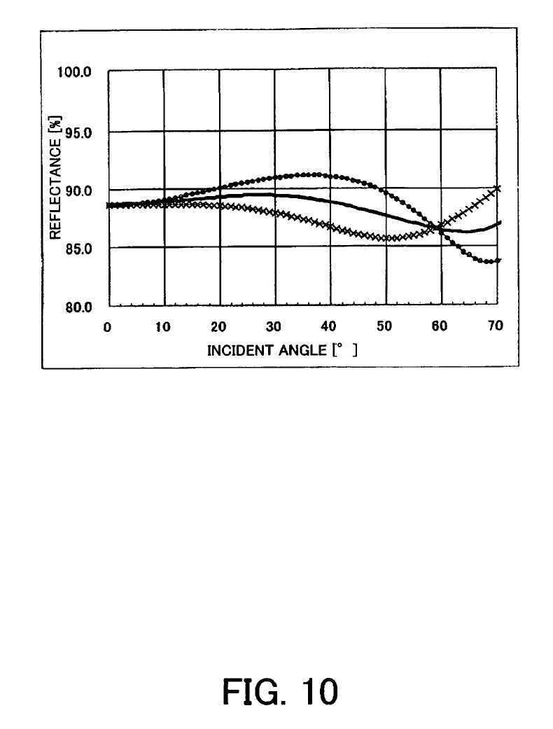

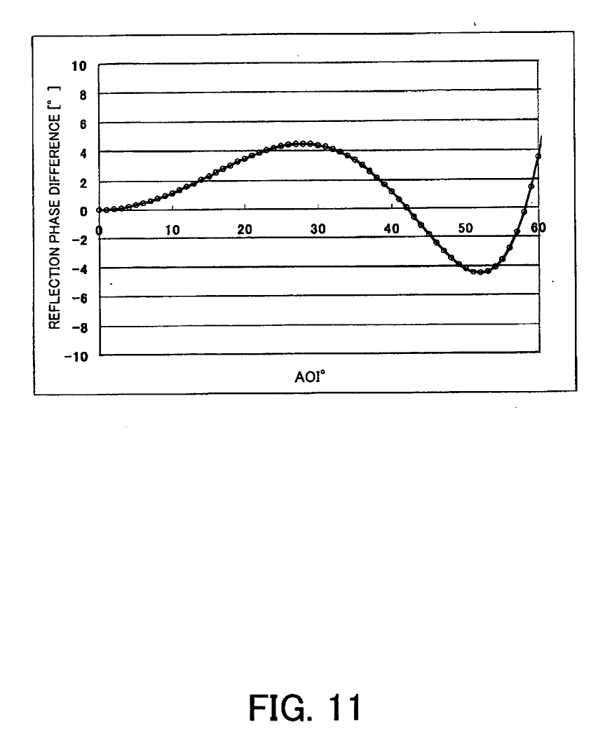

An optical thickness of the high index material is set to H, and an optical thickness of the low index material is set to L. When a film composition of 3 layers is set to 0.08L/0.33H/0.38L, the average reflectance becomes 86.4%, the maximum reflection phase difference becomes 7.70, and the maximum P and s-polarized lights separation difference becomes 4% in the incident angle of 30 to 60°. Even if each film thickness is within ±4% range from the above value, the average reflectance is within 86.7%, the reflection phase difference is within 15° or less, and P and s-polarized lights separation difference is within 5%. When a film composition of 4 layers is set to 0.45H/0.29L/0.34H/0.33L, the average reflectance becomes 88%, the maximum reflection phase difference becomes 4.7°, and the maximum p and s-polarized lights separation difference becomes 4.6% in the incident angle of 30 to 60°. Even if each film thickness is within ±3% range from the above value, the average reflectance is within 85%, the reflection phase difference is within 15° or less, and p and s-polarized lights separation difference is within 5%. A film design spectral property and simulation result of a phase difference of a 4 layers film are shown in FIG. 10 and FIG. 11. In FIG. 10, an O line is s-polarized light, a x line is p-polarized light, and a continuous line is an average random polarization reflectance of the s-polarized light and p-polarized light. An AOI in FIG. 11 is an incident angle (angle of incidence). The reflection phase difference is controlled to 5° or less in a large degree of the incident angle of 0 to 60°.

### FIRST EMBODIMENT

In the composition shown in FIG. 1, a synthesis quartz is used for the substrate 11, a metal aluminum of 100 nm is formed by using the electronic beam vacuum evaporation method at the room temperature. A background pressure of a vacuum evaporation chamber is 1.0×10⁻⁵ Pa, and a purity of the used metal aluminum material is 6N. The metal aluminum film is oxidized using the ion gun in the vacuum evaporation chamber immediately after forming the film, and the aluminum oxide film (alumina film) is formed. Concretely, the oxygen plasma of 140 V and 10 A (a current of the oxygen plasma which actually hits the aluminum film is 2 A or less from ionization efficiency etc.) is irradiated for 15 minutes on an ion gun apparatus, and the surface of the Al layer 12 is oxidized. A thickness of the alumina layer (aluminum oxide film) is 4 to 6 nm. When the using wavelength is set to 193 nm, the optical thickness is 7 to 11 nm (calculates with the refractive index of 1.8). Next, a fluoridation film (dielectric layer 16) is formed on the alumina layer 14 by using the sputtering method. The film composition is above 4 layers film composition, a lanthanum fluoride is used for the first layer and third layer, an aluminum fluoride is used for the second layer, and an aluminum fluoride is used for the fourth layer.

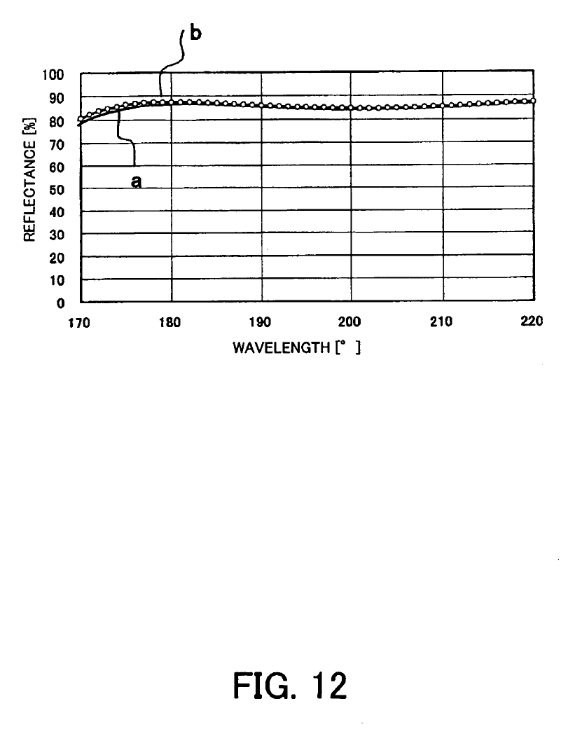

The fabricated mirror has an optical property that the average reflectance is 85.5%, the maximum polarization separation difference is 4.62% and 10° in the incident angle of 30° to 60°. FIG. 12 is shown for the optical property before and after of the laser durability experiment. Although ArF excimer laser of 1 mJ/cm² is irradiated for 3.7×10+9 pls, the reflectance does not deteriorate.

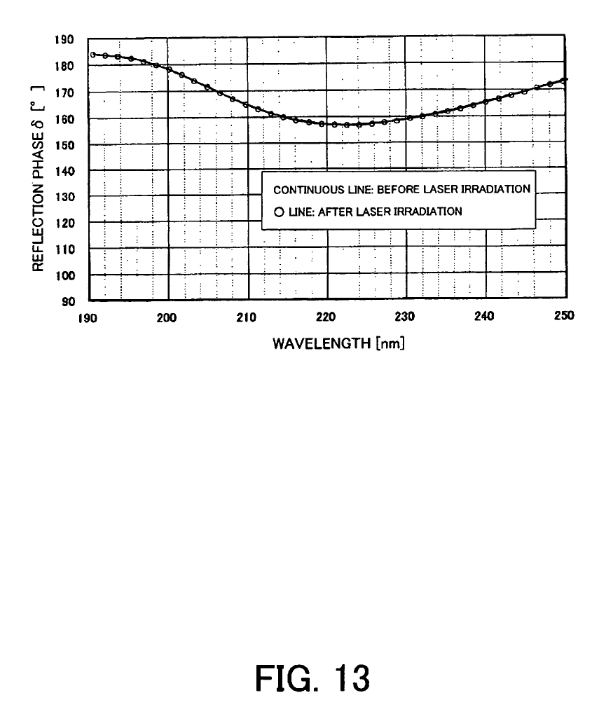

Concerning the reflection phase difference, the measurement result of the wavelength and the phase difference before and after of the laser durability experiment measured with the incident angle of 45° is shown in FIG. 13. A continuous line is a reflection phase before laser irradiation, and an O line is the measurement result of the reflection phase after laser irradiation. The measured value does not change between before and after laser irradiation, the reflection phase does not change at all.

The instant embodiment can especially improve the laser durability by providing the alumina layer 14 between the Al layer 12 and the dielectric layer 16. The reflection difference and p and s-polarized lights separation difference can be controlled to low in the large incident angle of 45°±15° by setting the film composition of the dielectric layer 16 to the optimal.

### SECOND EMBODIMENT

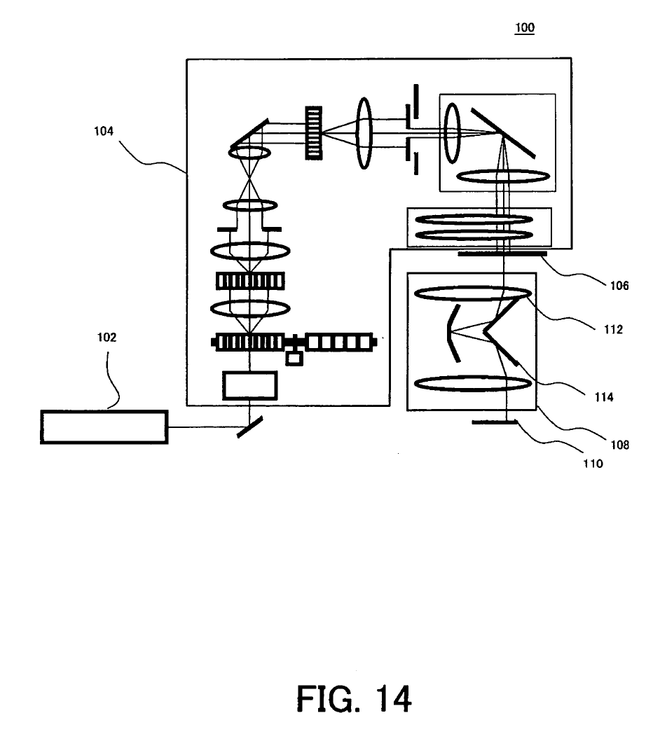

Hereafter, referring to FIG. 14, a description will be given of an exposure apparatus 100 as one aspect according to the present invention. FIG. 14 is a schematic block diagram of the exposure apparatus 100. A light source 102 uses ArF excimer laser with a wavelength of 193 nm. 104 is an illumination optical system, includes optical elements, such as a lens and a mirror, and illuminates a mask (illuminated surface) 106 by a predetermined light intensity distribution and polarization state. A light transmitted the mask 106 reaches a wafer 110 through a projection optical system 108, and transfers a pattern of the mask 106 onto the wafer 110.

The projection optical system 108 of the exposure apparatus 100 is, in the instant embodiment, a catadioptric optical system, and includes a lens 112 and a mirror 114. Here, the mirror 114 uses the mirror of the first embodiment. Therefore, the mirror 114 has superior laser durability, can be small the phase difference between p-polarized light and s-polarized light, and achieves superior polarization property.

### THIRD EMBODIMENT

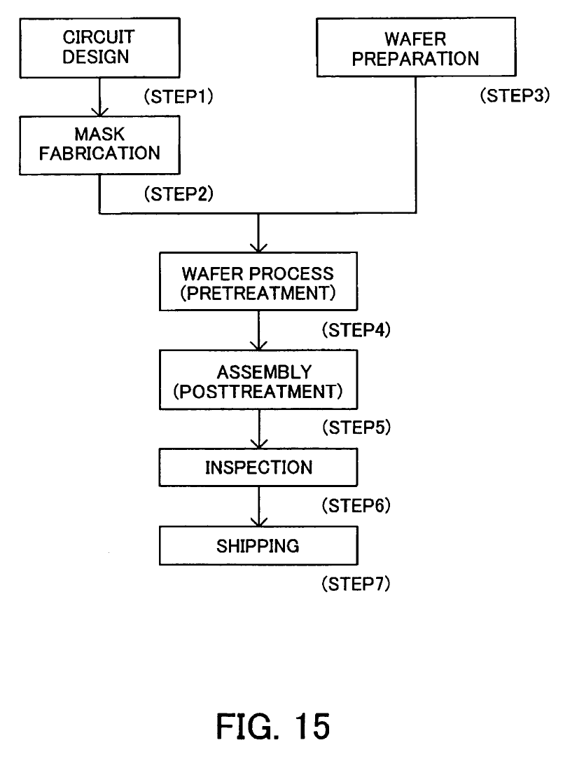

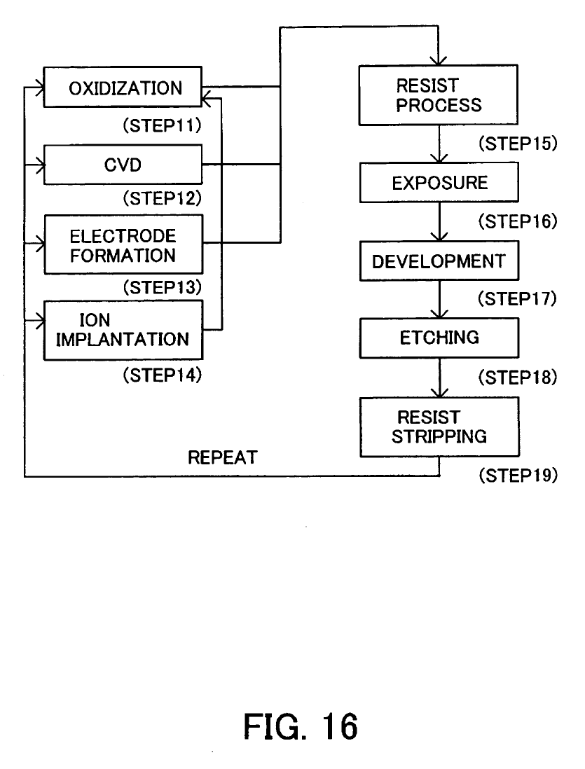

Referring now to FIGS. 15 and 16, a description will be given of an embodiment of a device fabrication method using the above mentioned exposure apparatus 1. FIG. 15 is a flowchart for explaining how to fabricate devices (i.e., semiconductor chips such as IC and LSI, LCDs, CCDs, and the like). Here, a description will be given of the fabrication of a semiconductor chip as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 16 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 100 to expose a circuit pattern from the mask onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The device fabrication method of this embodiment may manufacture higher quality devices than the conventional one. Thus, the device fabrication method using the exposure apparatus 100, and resultant devices constitute one aspect of the present invention.

Furthermore, the present invention is not limited to these preferred embodiments and various variations and modifications may be made without departing from the scope of the present invention.

This application claims a foreign priority benefit based on Japanese Patent Applications No. 2005-021912, filed on Jan. 28, 2005, which is hereby incorporated by reference herein in its entirety as if fully set forth herein.

What is claimed is:

1. A mirror used for a laser beam, said mirror comprising:
a substrate;
an aluminum layer formed on the substrate;
a dielectric layer formed on the aluminum layer; and
an aluminum oxide layer provided between the aluminum layer and the dielectric layer,
wherein said aluminum oxide layer has an optical thickness nd of 3.7 nm or more, where n is a refractive index for a using wavelength and d is a physical thickness.

2. A mirror according to claim 1, wherein said aluminum oxide layer has the optical thickness nd of 20 nm or less.

3. A mirror according to claim 1, wherein the number of dielectric layers is between 1 and 4.

4. A mirror according to claim 1, wherein said dielectric layer has an optical thickness between 43 nm and 300 nm.

5. A mirror according to claim 1, wherein said dielectric layer includes a pair of a low refractive index layer that has a refractive index smaller than a refractive index of the substrate and a high refractive index layer that has a refractive index higher than the refractive index of the substrate,
wherein said high refractive index layer is made of one or more components selected from among LaF₃, GdF₃, NdF₃, SmF₃, DyF₃, Al₂O₃, PbF₂, HfO₂, Yf₃, and a mixture thereof, and
wherein said low refractive index layer is made of one or more components selected from among AlF₃, MgF₂, NaF, LiF, CaF₂, BaF₂, SrF₂, SiO₂, Na₃AlF₆, Na₅Al₃F₁₄, and a mixture thereof.

6. A mirror used for a laser beam, said mirror comprising:
a substrate;
an aluminum layer formed on the substrate; and
a dielectric layer formed on the aluminum layer,
wherein an average reflectance is 85% or more, a reflection phase difference is ±15° or less, and a difference between a reflected p-polarized light and a reflected s-polarized light is within 10%, within an angular range of a central incident angle of 45° to ±15°.

7. A fabrication method for fabricating a mirror, said fabrication method comprising steps of:
forming an aluminum layer on a substrate;
forming an aluminum oxide layer having an optical thickness of 3.7 nm or more by oxidizing a surface of the aluminum layer, where n is a refractive index for a using wavelength and d is a physical thickness; and
forming a dielectric layer on the aluminum oxide layer.

8. An exposure apparatus comprising:
an illumination optical system for illuminating a pattern of a mask using a laser beam from a laser light source; and
a projection optical system for projecting the pattern onto an object,
wherein at least one of the illumination optical system and the projection optical system includes a mirror according to claim 1.

9. An exposure apparatus comprising:
an illumination optical system for illuminating a pattern of a mask using a laser beam from a laser light source; and
a projection optical system for projecting the pattern onto an object,
wherein at least one of the illumination optical system and the projection optical system includes a mirror according to claim 6.

10. A device fabrication method comprising the steps of:
exposing an object using an exposure apparatus according to claim 8; and
performing a development process for the object exposed.

11. A device fabrication method comprising the steps of:
exposing an object using an exposure apparatus according to claim 9; and
performing a development process for the object exposed.
